(19) United States
(12) Patent Application Publication
(10) Pub. No.: US 2003/0159255 A1
(43) Pub. Date: Aug. 28, 2003

(54) Clamp retention device

(76) Inventors: Craig A. Senovich, Murfreesboro, TN (US); Scott D. Webb, Smyrna, TN (US)

Correspondence Address: MR. CURTIS H. CASTLEMAN, THE GATES CORPORATION, MS: 31-4-A3, 900 SOUTH BROADWAY, DENVER, CO, 80209, US

(21) Appl. No.: 10/086,752

(22) Filed: Feb. 28, 2002

(51) Int. Cl. F16L 33/02; F16L 33/00

(52) U.S. Cl. 24/20 R

(57) ABSTRACT

A clamp retention device for positioning an open, generally cylindrical hose clamp on a hose extends generally about a longitudinal axis and has locating projections and cams for cooperating with the clamp and coupling the clamp to the retention device to hold the clamp disposed about said longitudinal axis. The body of the retention device may include at least one preformed perforation to receive a fastener for attaching the retention device to the hose. The fastener is preferably in the form of a wire staple or a rivet received through a perforation formed in a tab at one end of the retention device to be adjacent to the hose.

### FIELD OF THE INVENTION

This invention relates to securing deformable hoses on rigid tubular fittings such as those found in automobile engines to provide a fluid tight seal between a hose and a fitting. More particularly, the invention relates to a hose clamp retention device to position and retain a clamp on a hose ready to be activated after the hose has been positioned over a rigid tubular fitting.

### BACKGROUND OF THE INVENTION

Hose clamps have been designed in a great variety of forms. One type is a clamp of spring steel made to have a diameter slightly smaller than that of the outside diameter of the hose. As a result, when the clamp is pre-loaded by deforming it to enlarge the clamp, there will be stored energy in the clamp which can be released to apply a compressive radial force to hold the clamp on the hose.

A variation of the pre-loaded type is a clamp made of spring steel and shaped to be enlarged into an open position at the point of manufacture to store energy. The clamp is retained in this open condition either by a built-in restraining structure or by a keeper in the form of a clip. In use, the clamp is released over the hose to clamp the hose.

It has become common practice to pre-assemble clamps on a hose and provide this assembly to the automobile assembly line. The clamps are typically placed on the hose and either glued in position or attached to the hose with rivets at a point diametrically opposite the restraining structure or held in place by a clamp retention device which engages the hose to hold the clamp in place. The clamp is then in place to be released into a condition to apply a radial compressive load on the hose.

In order to position a clamp retention device on a hose, the clamp retention device itself will have a retainer comprising a retainer belt with free ends which couple together to locate on the hose in side-by-side relationship with a clamp locator that holds the clamp. Such a clamp retention device is described in U.S. Pat. No. 5,915,739.

The clamp retention device is preferred over attaching the clamp directly to the hose because of difficulties which arise in aligning the clamp and ensuring that the clamp is orthogonal to the hose. However, a clamp retention device which comprises both a clamp locator and a retainer belt occupies space along the length of a hose and this is not always available where a hose fitting is used in a crowded environment.

An object of this invention is to provide alternative means for securing a hose clamp retention device to a hose which obviates the need for a retainer belt.

### SUMMARY OF THE INVENTION

In accordance with the invention, there is provided a clamp retention device for positioning an open, generally cylindrical hose clamp on a hose. The retention device extends generally about a longitudinal axis and has at least one locator for cooperating with the clamp and coupling the clamp to the retention device to hold the clamp disposed about said longitudinal axis. The retention device may further includes at least one preformed perforation to receive therethrough at least one fastener for attaching the retention device to the hose. Preferably, the retention device has a body with at least one dependent tab integrally formed with the body and extending longitudinally from the body at one end thereof for receiving therethrough fastening means, preferably in the form of a wire staple or a rivet.

### BRIEF DESCRIPTION OF DRAWINGS

In order to better understand the invention, a preferred embodiment is described below with reference to the accompanying drawings, in which:

FIG. 1 is a perspective view of a hose clamp retention device according to the invention shown assembled with a clamp from one side;

FIG. 2 is a similar view to FIG. 1 from the other side;

FIG. 3 is a similar view to FIG. 1 showing the hose clamp retention device without the associated clamp;

FIG. 4 is a top plan view of the hose clamp retention device of FIG. 3 (without a staple);

FIG. 5 is a front side elevation view of the hose clamp retention device of FIG. 3 (without a staple);

FIG. 6 is an exploded assembly view of the hose clamp retention device of FIG. 1, assembly on a hose;

FIG. 7 is a perspective view showing the components of FIG. 6 assembled together on a rigid tubular fitting;

FIG. 8 is a cross-sectional view of the assembly of FIG. 7, drawn online 8-8 of FIG. 7;

FIG. 9 is a similar view to FIG. 3 of a first alternative embodiment of a hose clamp retention device made in accordance with the invention; and

FIG. 10 is a similar view to FIG. 3 of a second alternative embodiment of a hose clamp retention device made in accordance with the invention.

### DESCRIPTION OF THE PREFERRED EMBODIMENT

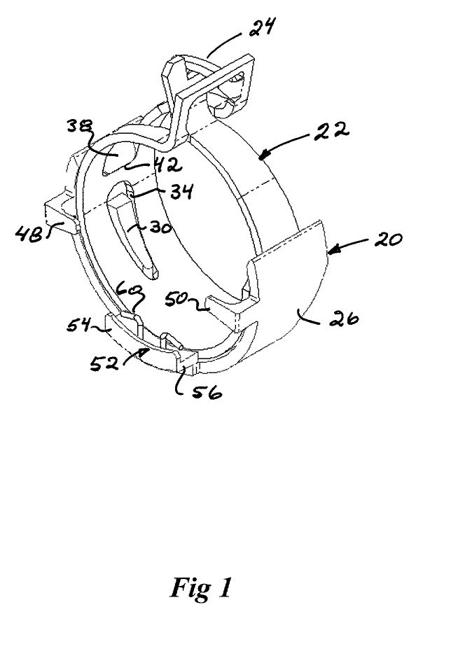

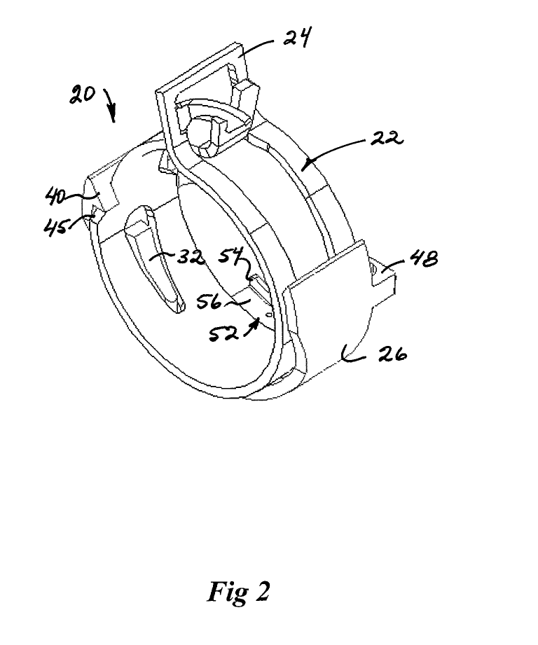

Reference is first made to FIGS. 1 and 2 which illustrate an injection molded hose clamp retention device indicated generally by the numeral 20 and containing an exemplary hose clamp indicated generally by the numeral 22. The hose clamp is generally cylindrical and is of the pre-stressed type incorporating a latch structure 24 to hold the clamp in an open position for engagement over a hose. It will be evident from the following description that the hose clamp 22 is exemplary of a variety of clamps and that the retention clamp 20 can be used with such clamps.

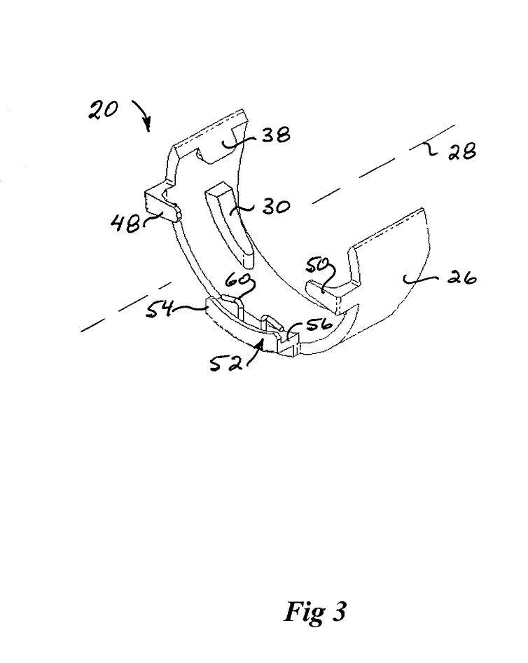

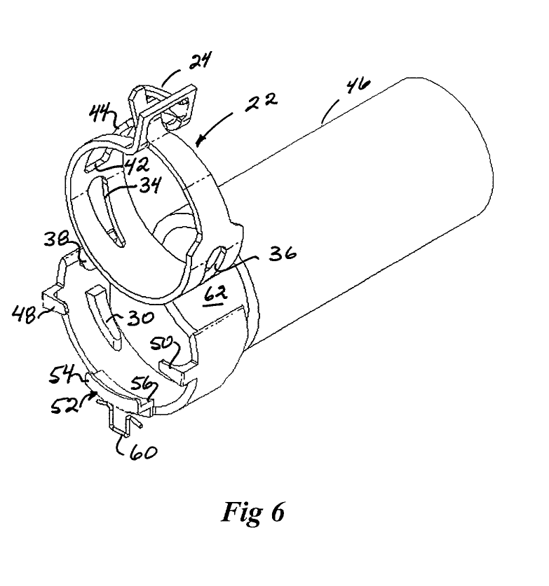

The retention device 20 shown in FIGS. 3 to 5 without a clamp consists essentially of a retainer body 26 made of propylene or nylon and which extends generally about a longitudinal axis 28. The body 26 is generally C-shaped and is proportioned to be a snap-fit on the clamp 22. C-shaped body 26 has a pair of inwardly extending projections 30, 32 provided on an inwardly facing surface of the body 26 for engagement in respective openings 34, 36 formed in the clamp 22 and shown in FIG. 6. The retainer body 26 also has a pair of projecting cams 38, 40 disposed on the C-shaped body 26 at opposite free ends thereof (best seen in FIG. 5). The cam 38 is centrally disposed in the retainer body 26 and locates against a shoulder 42 defined by an opening 44 formed in the clamp 22, as best seen in FIG. 6 while the cam 40 is disposed to one side of the retainer body 26 and locates against shoulder 45 formed by an undercut in the side of the clamp 22, as best seen in FIG. 2. Consequently, when the clamp 22 is engaged in the retainer body 26 by deforming the body to receive the clamp, the projections 30, 32 and cams 38, 40 locate the clamp angularly with respect to the body to restrict radial movement of the clamp 22. As mentioned previously, the exemplary clamp 22 is in an expanded or open condition retained in this form by the latch structure 24 ready to be released into a deployed position. However, other types of clamps can be accommodated for conventional actuation.

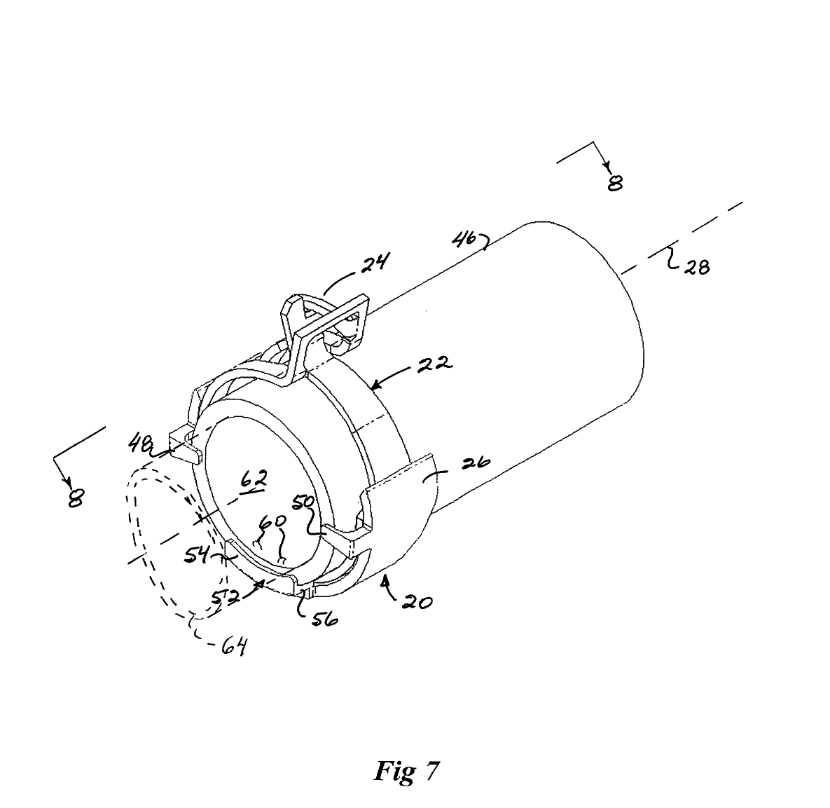

In order to limit relative longitudinal movement between the clamp retention device 20 and a hose 46 disposed longitudinally inside the clamp 22 as shown in FIG. 7, the body 26 also has a pair of oppositely disposed, radially inwardly extending locating tabs 48, 50. The locating tabs 48, 50 have an L-shaped cross-section and extend longitudinally from the body 26 at one end thereof so that when assembled with the hose 46 with one end of the hose proud of the body 26 to extend a short distance therefrom, the hose 46 will abut against the locating tabs 48, 50.

A third locating tab 52 of similar shape and orientation to tabs 48, 50 is disposed therebetween so as to lie diametrically opposite to the latch structure 24 of the clamp 22. The tab 52 likewise extends longitudinally from the body 26 on the same side as the locating tabs 48, 50 and has a radially inwardly extending lip portion 54 for location against the free end of the hose 46 to limit relative longitudinal movement between the clamp retention device 20 and the hose 46.

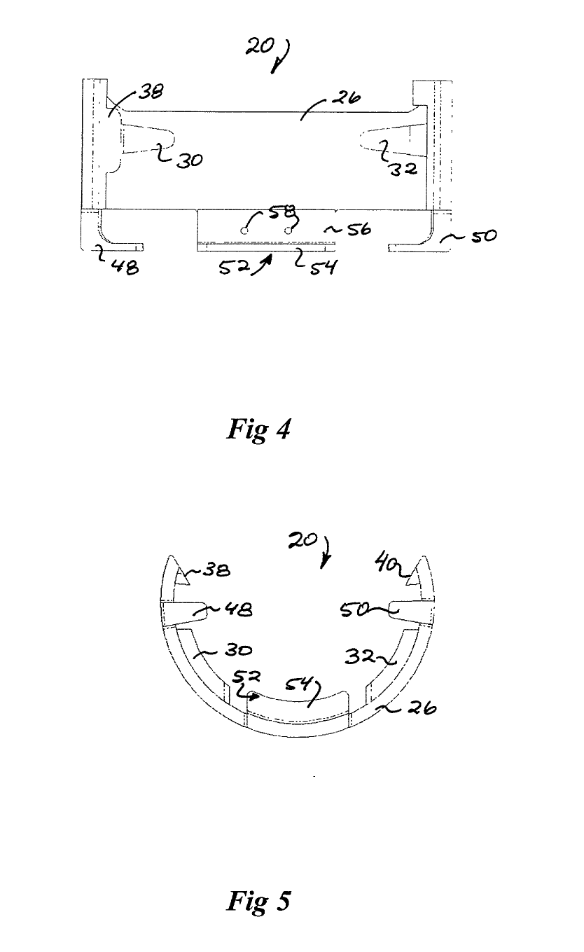

A longitudinally extending portion 56 of the locating tab 52 has a pair of spaced preformed perforations 58 formed therein as clearly shown in FIG. 4. The separation between the perforations 58 is selected to receive the free ends of a U-shaped staple 60 (FIG. 1, 6) prior to bending the legs of the staple over the inside surface 62 of the hose 46. The hose clamp retention device 20 is shown assembled with a clamp 22 on a hose 46 in FIG. 7 where it will be seen that the staple 60 has penetrated the wall of the hose 46.

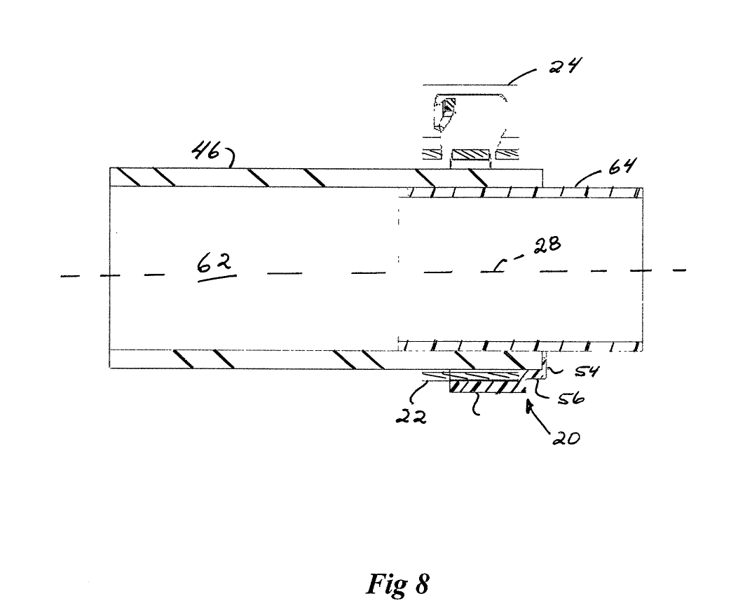

In order to facilitate penetration of the hose 46 with the staple 60, the locating tab 52 is radially inwardly disposed on the body 26 to lie closer to the longitudinal axis 28. The radial separation between the locating tab 52 and the interior surface of the body 26 is small, about the thickness of the band comprising the clamp 22 as seen most clearly in FIG. 8. The tab 52 is thereby adapted to lie adjacent to the exterior cylindrical surface of the hose 46 while the locating tabs 48, 50 are somewhat spaced from the exterior cylindrical surface of the hose 46.

Because the hose clamp retention device 20 is preferably molded from synthetic plastic material, the locating tabs 48, 50, 52 are integrally formed during molding. The perforations 58 may be preformed during the molding process so that the material comprising the retention device 20 will not shatter or fracture. The retention device 20 may also be molded from any other suitable material which can be perforated after molding, for example, by drilling, without shattering or fracturing.

Assembly of the device 20 on the hose 46 will next be described with reference being made to FIG. 7. The hose 46 is received in the device 20 with clamp 22 snapped into the generally C-shaped body 26. The body 26 extends radially about the clamp 22 with respect to the longitudinal axis 28 of the device such that the clamp is retained within the body 26. The hose 46 and clamp 22 are selected so that the hose 46 will slide through the clamp 22 as is common in the art. The assembly with the clamp 22 is positioned relative to the end of the hose 46 in a predetermined position limited by the locating tabs 48, 50, 52 abutting against the free end of the hose 46. The hose 46 is then secured to the assembly by means of the staple 60 which is received through the perforations 58 and which penetrates the body of the hose 46. The stapling of the assembly may be automated and performed in a jig to align staples 60 with the perforations.

It will be evident that when the hose 46 is engaged over a rigid tubular fitting 64, drawn in ghost outline in FIG. 7, the position of the clamp 22 on the hose should be such that when the engagement takes place upon release of latch 24, the clamp 22 will compress the hose 46 between the fitting 64 and the clamp 22. After the engagement on the fitting 64 is complete, the clamp 22 is deployed in the usual fashion so that the energy stored in the clamp compresses the hose 46 about the fitting 64.

The retention device 20 has been described as a one-piece injection molded structure. Clearly, the device can be manufactured differently and take many forms within the scope of the invention. All such variations will be evident to persons skilled in the art and are within the scope of the invention as claimed.

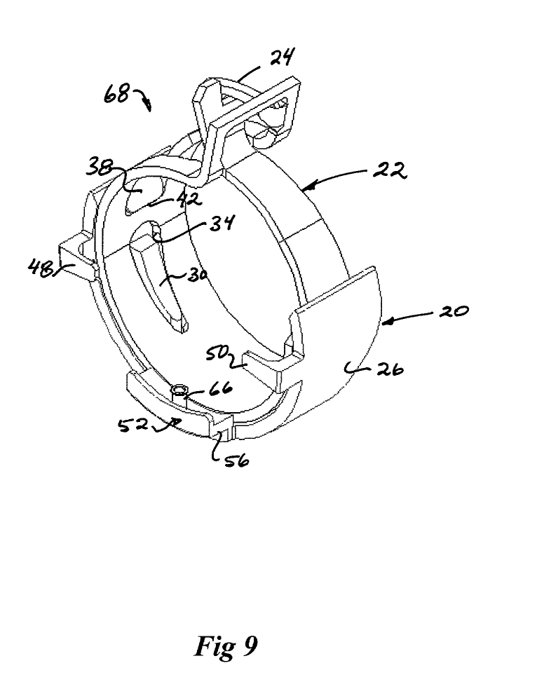

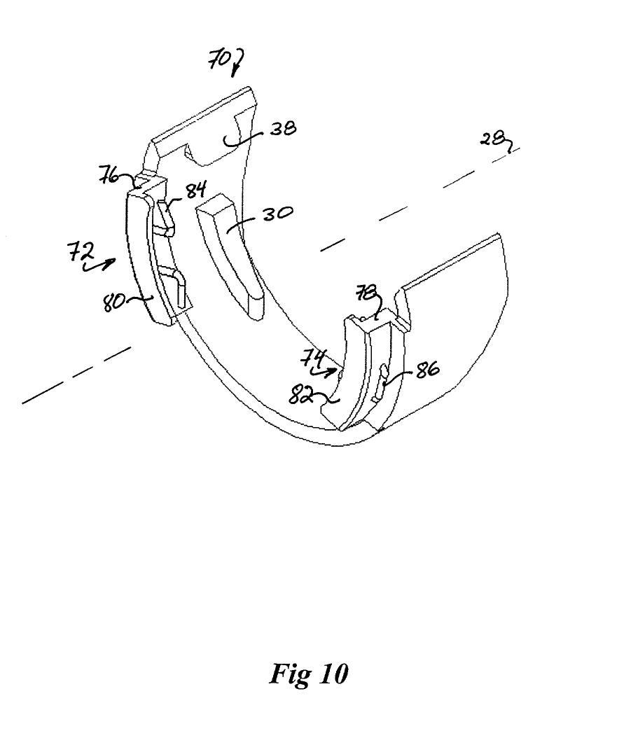

It will also be appreciated that the preformed perforations may be sized to receive fasteners other than staples, such as a rivet 66 shown in the hose clamp retention device 68 of FIG. 9. The device 68 is otherwise similar to the device 20 and like parts have been identified by like numerals. The hose clamp retention device may also be modified to have a plurality of radially spaced tabs each with respective perforations to receive a fastener to secure the device to a hose. Such a modified hose clamp retention device 70 is shown in FIG. 10 and has a pair of oppositely disposed locating tabs 72, 74 at one end of the device 70 and disposed radially opposite one another.

The locating tabs 72, 74 like the locating tab 52 of the hose clamp retention device 20 of FIGS. 1 to 9, extend longitudinally from the C-shaped body of the hose clamp retention device in respective longitudinal portions 76, 78 which terminate in respective radially inwardly extending lip portions 80, 82. The longitudinal portions 76, 78 have respective preformed perforations (not shown) formed therein to receive the free ends of a respective U-shaped staple 84, 86. It will be noted that the longitudinal portions 76, 79 of the locating tabs 72, 74 are radially inwardly disposed to lie closer to the longitudinal axis 28, similarly to locating tab 52. This brings the tabs 72, 74 closer to lie adjacent to the exterior surface of a hose to which the hose clamp retention device 70 is to be coupled.

The hose clamp retention device 70 is thereby adapted for retaining larger diameter clamps and hoses.

Similarly to the hose clamp retention device 20 of FIGS. 1 to 8, the device 70 has locating projection 30, 32 (only of which can be seen in FIG. 10) and locating cams 38, 40 (only one of which can be seen in FIG. 10).

Still more variations to the hose clamp retention device according to the invention may be made as will be apparent to those skilled in the art within the scope of the appended claims.

1. A clamp retention device for positioning an open generally cylindrical hose clamp on a selected hose in preparation for engaging the hose over a rigid tubular fitting, the device having a body which extends generally about a longitudinal axis, the body having
at least one locator for cooperating with the clamp and for coupling the clamp to the retention device to hold the clamp disposed about said longitudinal axis, and
at least one dependent tab integrally formed with the body and extending longitudinally from the body at one end thereof.

2. A clamp retention device according to claim 1 in which the body has at least one preformed perforation formed in said tab for receiving therethrough at least one fastener for attaching the clamp retention device to the hose.

3. A clamp retention device according to claim 1 in which said at least one tab is radially inwardly disposed on said body to lie closer to said longitudinal axis and adapted to lie adjacent to the hose.

4. A clamp retention device according to claim 3 in which the tab has a radially inwardly extending lip for location against a free end of the hose and for limiting relative longitudinal movement between the clamp retention device and the hose.

5. A clamp retention device according to claim 1 having a number of tabs radially spaced from each other on said body at one end of said body.

6. A clamp retention device according to claim 5 in which each said tab has a respective pair of preformed perforations formed therein and spaced from each other a predetermined distance for receiving a wire staple for fastening the device to a hose.

7. An assembly for coupling a rigid tubular fitting to a hose to provide fluid flow therebetween, the assembly having:
an elongate hose having a free end for engagement over said tubular fitting;
a clamp in an open condition and positioned to slide freely on the hose and provide clearance for radial outward deflection of the hose; and
a clamp retention device for positioning the open clamp near said free end of the hose ready to be deployed to compress the hose on said tubular fitting, the device having a body which extends generally about a longitudinal axis, the body having at least one locator for cooperating with the clamp and for coupling the clamp to the retention device to hold the clamp disposed about said longitudinal axis, and at least one perforation formed in said body receiving therethrough at least one fastener for attaching the clamp retention device to the hose.

8. An assembly according to claim 7 in which the body has at least one dependent tab integrally formed with the body and extending longitudinally from the body at one end thereof, said at least one perforation being formed in said tab;
said at least one tab being radially inwardly disposed on said body to lie closer to said longitudinal axis and adapted to lie adjacent to the hose and
the tab having a radially inwardly extending lip for location against said free end of the hose and for limiting relative longitudinal movement between the clamp retention device and the hose.

9. A clamp retention device according to claim 8 having a number of tabs radially spaced from each other on said body at one end of said body.

10. A clamp retention device according to claim 9 in which each said tab has a respective pair of perforations formed therein and spaced from each other a predetermined distance for receiving a wire staple for fastening the device to the hose.
